(19) United States
(12) Patent Application Publication
(10) Pub. No.: US 2023/0304231 A1
(43) Pub. Date: Sep. 28, 2023

(54) METHOD FOR OPERATING A SOIL COMPACTOR AND SOIL COMPACTOR

(71) Applicant: Hamm AG, Tirschenreuth (DE)

(72) Inventor: Rainer KROCKAUER, Plössberg (DE)

(21) Appl. No.: 18/124,468

(22) Filed: Mar. 21, 2023

(30) Foreign Application Priority Data
Mar. 22, 2022 (DE) 10 2022 106 657.6

(51) Int. Cl. E01C 19/28; B06B 1/16

(52) U.S. Cl. CPC E01C 19/286; B06B 1/16

(57) ABSTRACT

A soil compactor includes two compactor rollers arranged at a distance from one another in the direction of a longitudinal axis of the soil compactor and rotatable around a respective roller axis of rotation, each compactor roller is operable in an oscillatory compaction mode in which the vibration excitation arrangement assigned to a respective compactor roller is operated in the oscillatory vibration excitation mode, in a vibratory compaction mode in which the vibration excitation arrangement assigned to a respective compactor roller is operated in the vibratory vibration excitation mode, and in a static compaction mode in which the vibration excitation arrangement is deactivated. When the soil compactor is moved in a plurality of successive compactor passes over soil to be compacted with alternating movement of the soil compactor essentially in the first movement direction and essentially in the second movement direction, during at least one pass, the trailing compactor roller is not operated in the vibratory compaction mode.

The present invention relates to a method for operating a soil compactor and a soil compactor, which has two compactor rollers which are arranged at a distance from one another in the direction of a soil compactor longitudinal axis and are rotatable around a respective roller axis of rotation, and for compacting soil material in a plurality of successively traveled compactor passes, is movable essentially in the direction of the soil compactor longitudinal axis in a first movement direction and a second movement direction essentially opposite to the first movement direction. In order to influence the compaction behavior, each of the compactor rollers is assigned a vibration excitation arrangement, wherein each vibration excitation arrangement is designed to to exert an oscillation torque on the assigned compactor roller around its axis of rotation in an oscillatory vibration excitation mode and to exert a vibration force on the assigned compactor roller essentially orthogonally to its roller axis of rotation in a vibratory vibration excitation mode.

A compactor roller for a soil compactor is known from WO 2013/113819 A1, in which in an oscillatory vibration excitation mode, a vibration excitation arrangement can exert an oscillation torque on the compactor roller, in order to apply a torque around its axis of rotation periodically thereto, which accelerates the compactor roller back and forth in the circumferential direction. By exerting such a periodic oscillation torque and a periodic back-and-forth rotational movement of the compactor roller thus induced, which is superimposed on the rolling movement thereof, a kneading effect or flexing effect is generated which, in particular if the soil to be compacted is built up with asphalt material, contributes to improved compacting in particular in the area near the surface. The vibration excitation arrangement of this known compactor roller can, in a vibratory mode, exert a force orthogonal to the axis of rotation in order to act on the soil to be compacted with a percussive movement for increased compaction thereof.

In this known compactor roller, the vibration excitation arrangement comprises an oscillation arrangement having two oscillating mass units, which comprise oscillating unbalanced masses, which are rotatable around oscillation axes of rotation parallel to the axis of rotation of the roller but radially offset in relation thereto. A vibration arrangement of this known compactor roller comprises a vibration unbalanced mass which, in the vibratory oscillation excitation mode, is rotatable around an axis of rotation corresponding to the axis of rotation of the roller. Depending on whether the compactor roller is to be operated in an oscillatory compaction mode or a vibratory compaction mode, either the oscillating unbalanced masses of the oscillation arrangement are driven to rotate around their axes of rotation or the vibration unbalanced mass of the vibration arrangement is driven to rotate around its axis of rotation.

A compactor roller known from EP 0 053 598 A1 comprises a vibration excitation arrangement having two unbalanced masses, which are rotatable around the axis of rotation parallel to the axis of rotation of the roller but eccentric with respect thereto. By adjusting the phasing of the centers of mass of the unbalanced masses with respect to one another, this vibration excitation arrangement can be switched between an oscillatory vibration excitation mode and a vibratory vibration excitation mode.

It is the object of the present invention to provide a method for operating a soil compactor and a soil compactor using which an improved compaction result is achieved with efficient use of the soil compactor.

According to the invention, this object is achieved by a method for operating a soil compactor, the soil compactor comprising two compactor rollers arranged at a distance from one another in the direction of a longitudinal axis of the soil compactor and rotatable around a respective axis of rotation of the rollers, wherein the soil compactor is movable essentially in the direction of the soil compactor longitudinal axis in a first movement direction and a second movement direction essentially opposite to the first movement direction to compact soil material, wherein when the soil compactor moves in the first movement direction, one of the compactor rollers is a compactor roller leading in the first movement direction and the other of the compactor rollers is a compactor roller trailing in the first movement direction and when the soil compactor moves in the second movement direction, one of the compactor rollers is the compactor roller trailing in the second movement direction and the other of the compactor rollers is the compactor roller leading in the second movement direction, wherein each of the compactor rollers is assigned a vibration excitation arrangement, wherein each vibration excitation arrangement is designed to exert an oscillation torque on the associated compactor roller around its roller axis of rotation in an oscillatory vibration excitation mode and to exert a vibration force on the assigned compactor roller essentially orthogonally to its roller axis of rotation in a vibratory vibration excitation mode, wherein each compactor roller is operable:
in an oscillatory compaction mode, wherein in the oscillatory compaction mode the vibration excitation arrangement assigned to a respective compactor roller is operated in the oscillatory vibration excitation mode,
in a vibratory compaction mode, wherein in the vibratory compaction mode the vibration excitation arrangement assigned to a respective compactor roller is operated in the vibratory vibration excitation mode,
in a static compaction mode, wherein in the static compaction mode the vibration excitation arrangement assigned to a respective compactor roller is deactivated,
   wherein when the soil compactor is moved in a plurality of successive compactor passes over soil to be compacted with alternating movement of the soil compactor essentially in the first movement direction and essentially in the second movement direction, during at least one pass, the trailing compactor roller is not operated in the vibratory compaction mode.

By operating the soil compactor in such a way that in at least one of the compactor passes of the plurality of successive compactor passes, in each of which the soil compactor moves in essentially opposite movement directions, the trailing compactor roller, i.e., the respective rear compactor roller in the movement direction, is not operated in the vibratory compaction mode, i.e., is operated either in the oscillatory compaction mode or in the static compaction mode, it is ensured that after such a pass has been carried out, a surface structure having a large number of successive impact troughs in the respective movement direction is not generated by the percussive impact on the soil to be compacted in the vibratory compaction mode. A smoothing of the surface structure is ensured by a trailing compactor roller, which is operated either in the static compaction mode or in the oscillatory compaction mode.

It is particularly advantageous if at least during a last compactor pass of the plurality of compactor passes, the trailing compactor roller is not operated in the vibratory compaction mode, since after the last pass essentially no further measures affecting the surface structure of the then compacted soil are carried out.

A particularly smooth surface structure of the compacted soil, which is essentially unaffected by irregularities generated by the compaction process itself, with efficient compaction operation nonetheless, can be achieved if the trailing compactor roller is not operated in the vibratory compaction mode in each compactor pass of the plurality of compactor passes.

In order to be able to use the compaction generated by the percussive application to the soil in the vibratory compaction mode nonetheless, it is proposed that the leading compactor roller be operated in the vibratory compaction mode during at least one, preferably each compactor pass of the plurality of compactor passes.

In order to smooth out the irregularities on the surface of the soil to be compacted that are unavoidably generated in the vibratory compaction mode, the trailing compactor roller can advantageously be operated in the oscillatory compaction mode during at least one, preferably every compactor pass of the plurality of compactor passes. The kneading effect or flexing effect generated in the oscillatory compaction mode, in particular in the area near the surface of the soil to be compacted, not only generates a very compact structure in this area, but also the trough-like irregularities generated in a preceding vibratory compaction mode can be essentially completely eliminated.

The elimination of irregularities generated in vibratory compaction mode can also be achieved, for example, in that the trailing compactor roller can advantageously be operated in the oscillatory compaction mode during at least one, preferably every compactor pass of the plurality of compactor passes. The use of a static compaction mode for the trailing compactor roller can be particularly advantageous when sufficient compaction of the soil to be compacted has already been achieved in the area near the surface, but trough-like irregularities possibly generated in the preceding vibratory compaction mode are still to be eliminated.

The invention furthermore relates to a soil compactor, comprising:
two compactor rollers arranged at a distance from one another in the direction of a longitudinal axis of the soil compactor and rotatable around a respective roller axis of rotation, wherein the soil compactor is movable essentially in the direction of the soil compactor longitudinal axis in a first movement direction and a second movement direction essentially opposite to the first movement direction to compact soil material, wherein when the soil compactor moves in the first movement direction, one of the compactor rollers is a compactor roller leading in the first movement direction and the other of the compactor rollers is a compactor roller trailing in the first movement direction and when the soil compactor moves in the second movement direction, one of the compactor rollers is the compactor roller trailing in the second movement direction and the other of the compactor rollers is the compactor roller leading in the second movement direction,
each of the compactor rollers is assigned a vibration excitation arrangement, wherein each vibration excitation arrangement is designed to exert an oscillation torque on the associated compactor roller around its roller axis of rotation in an oscillatory vibration excitation mode and to exert a vibration force on the assigned compactor roller essentially orthogonally to its roller axis of rotation in a vibratory vibration excitation mode,
an activation unit for activating each vibration excitation arrangement, wherein each vibration excitation arrangement is operable by activation by means of the activation unit:
   in an oscillatory compaction mode, wherein in the oscillatory compaction mode the vibration excitation arrangement assigned to a respective compactor roller is operated in the oscillatory vibration excitation mode,
   in a vibratory compaction mode, wherein in the vibratory compaction mode the vibration excitation arrangement assigned to a respective compactor roller is operated in the vibratory vibration excitation mode,
   in a static compaction mode, wherein the vibration excitation arrangement assigned to a respective compactor roller is deactivated in the static compaction mode,
a movement direction detection unit for providing movement direction information representing the movement direction of the soil compactor,
wherein the activation unit is designed to activate the vibration excitation arrangements based on the movement direction information in such a way that when the soil compactor is moved in a plurality of successive compactor passes over soil to be compacted with alternating movement of the soil compactor essentially in the first movement direction and essentially in the second movement direction, during at least one pass, the trailing compactor roller is not operated in the vibratory compaction mode.

In such a soil compactor, the activation unit can be designed to carry out a method according to the invention.

The present invention is described in detail below with reference to the attached figures. In the figures:

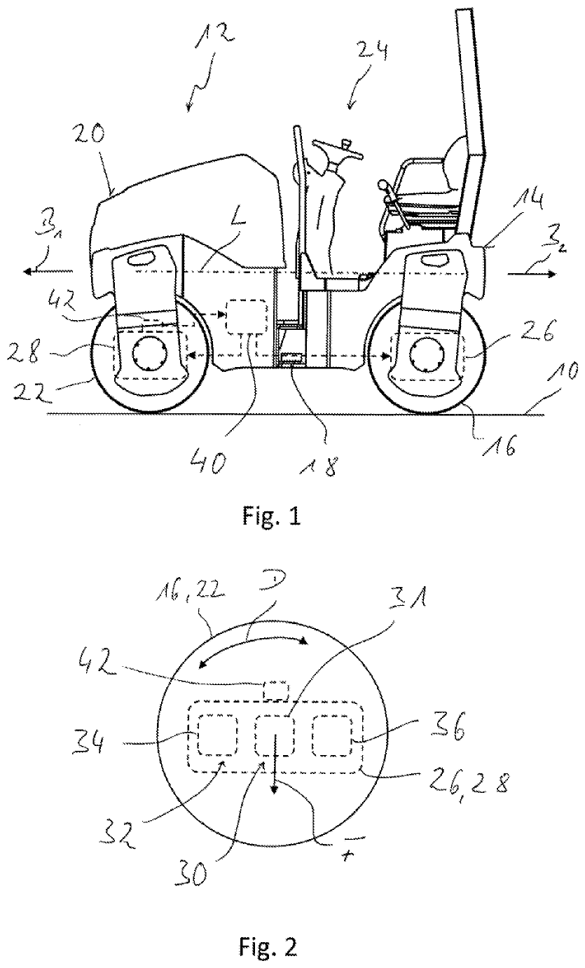

FIG. 1 shows a side view of a soil compactor having two compactor rollers;

FIG. 2 shows a schematic side view of a compactor roller with a vibration excitation arrangement assigned thereto

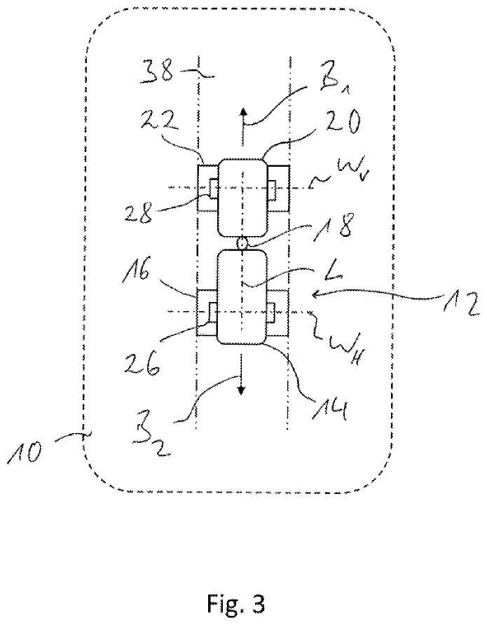

FIG. 3 shows a top view of a soil compactor shown schematically in compaction mode.

In FIG. 1, a soil compactor that is also usable in particular for compacting a soil 10 built up with asphalt material is denoted generally by 12. The soil compactor 12 comprises a rear carriage 14 on which a compactor roller 16 is supported so as to be rotatable around a roller axis of rotation W_{H}. On a front carriage 20 of the soil compactor 12, which is pivotably connected to the rear carriage 14 in the area of an articulated joint 18, a compactor roller 22 is supported so as to be rotatable around a roller axis of rotation W_{V}. The two compactor rollers 16, 22 are arranged at a distance from one another in the direction of a soil compactor longitudinal axis L and, when the soil compactor 12 is traveling straight ahead, have roller axes of rotation W_{H}, W_{V} oriented essentially parallel to one another.

Furthermore, an operating stand generally designated by 24 is provided on the rear carriage 14, in which an operator can find a place to control the soil compactor 10 in the compaction mode.

In the compaction mode, the soil compactor 12 moves on the soil 10 to be compacted in two opposite movement directions B₁, B₂, essentially directed in the direction of the soil compactor longitudinal axis L. In the exemplary embodiment of a soil compactor shown in FIG. 1, the movement direction B₁ can correspond to a forward movement of the soil compactor 12, wherein the movement direction B₂ then corresponds to a reverse movement of the soil compactor 12.

When the soil compactor 12 moves in the first movement direction B₁, the compactor roller 22 provided on the front carriage 20 forms a leading compactor roller, which first travels over the soil 10 to be compacted, while the compactor roller 16 provided on the rear carriage 14 forms a trailing compactor roller, which only travels over the soil 10 to be compacted when it has already been traveled over by the leading compactor roller, thus the compactor roller 22 provided on the front carriage 20. Likewise, when the soil compactor 12 moves in the second movement direction B₂, the compactor roller 16 provided on the rear carriage 14 forms the leading compactor roller, while the compactor roller 22 provided on the front carriage 20 forms the trailing compactor roller. This means that when the soil compactor 12 moves alternately in the first movement direction B₁ and the second movement direction B₂, there is an alternating change in functionality as the leading compactor roller and as the trailing compactor roller for the two compactor rollers 16, 22.

Each of the two compactor rollers 16, 18 is assigned a respective vibration excitation arrangement 26, 28. In particular when the two compactor rollers 16, 18 are built identically to one another, in particular have the same dimensions, the vibration excitation arrangements 26, 28 can also be built identically to one another or have the same dimensions.

Each of the vibration excitation arrangements 26, 28 is designed to exert an oscillation torque D around the roller axis of rotation W_{H}, W_{V} of this compactor roller 16 or 22 in an oscillatory vibration excitation mode on the respectively associated compactor roller 16, 18, by which the compactor roller 16, 22 is accelerated back and forth substantially periodically in the circumferential direction around its roller axis of rotation W_{H}, W_{V}. This periodic back and forth acceleration or the periodic back and forth rotating movement of the compactor roller 16 or 22 around its roller axis of rotation W_{H}, W_{V} thus also generated is superimposed on the rolling movement of the compactor roller 16 or 22 and results in to a kneading effect or flexing effect especially in the area close to the surface of the soil 10 to be compacted.

Furthermore, each of the vibration excitation arrangements 26, 28 is designed, in a vibratory vibration excitation mode, to generate a vibration force F that is essentially orthogonal to the roller axis of rotation W_{H}, W_{V} of the respectively assigned compactor roller 16, 22 or to exert it on the respectively assigned compactor roller 16, 22. Such a vibratory force orthogonal to the roller axis of rotation W_{H}, W_{V} periodically presses or strikes the respective compactor roller 16 or 22 against the surface of the soil 10 to be compacted, so that this percussive impact on the soil 10 also causes increased compacting of the building material thereof extending farther into the depth. The periodic percussive impact on the soil 10 in vibratory vibration excitation mode as the soil compactor 12 advances over the soil 10 to be compacted has the result that a large number of successive, trough-like depressions can result in the respective movement direction B₁, B₂ of the soil compactor 12, in particular if the degree of compaction of the soil 10 to be compacted is still comparatively low.

FIG. 2 illustrates, by way of example and schematically, the design of the compactor rollers 16, 22 with the vibration excitation arrangements 26, 28 assigned to them or arranged in them. Each of these vibration excitation arrangements 26, 28 can comprise a vibration arrangement 30 having a vibration imbalance mass 31 drivable to rotate around a vibration axis of rotation. In the exemplary embodiment shown, the vibration axis of rotation corresponds to the respective roller axis of rotation W_{H}, W_{V}.

To generate the oscillation torque D, each of the oscillation excitation arrangements 26, 28 can comprise an oscillation arrangement 32, wherein the oscillation arrangement 32 can comprise two oscillation imbalance masses 34, 36, which are drivable to rotate around respective oscillation axes of rotation that are eccentric to the roller axis of rotation W_{H}, W_{V} but are parallel thereto. Depending on whether the respective vibration excitation arrangement 26, 28 is to be corrected in the oscillatory vibration excitation mode or in the vibratory vibration excitation mode, either the vibration arrangement 30 is activated while the oscillation arrangement 32 remains deactivated, or the oscillation arrangement 32 is operated while the vibration arrangement 30 remains deactivated. In a static compaction mode, in which compaction of the soil 10 to be compacted is to be achieved solely by the load on the soil to be compacted caused by the weight of the soil compactor 12, both the vibration arrangement 30 and the oscillation arrangement 32 can be deactivated or can remain deactivated in one or both of the compactor rollers 16, 28.

It is to be noted that only one example of the design of such vibration excitation arrangements 26, 28 was explained with reference to FIG. 2, which can correspond to the structure known from WO 2013/113819 A1 with regard to its structure or its function. Of course, each of the vibration excitation arrangements 26, 28 can also be constructed according to the principle disclosed in EP 0 053 598 A1, in which it is possible to switch between an oscillatory mode and a vibratory mode by changing the phasing of the centers of mass of unbalanced masses with respect to one another. However, a mode that is possible at least in the case of the structure illustrated in FIG. 2, in which both the oscillatory arrangement 32 and the vibratory arrangement 30 are put into operation, would not be possible with such a structure.

The activation of the vibration excitation arrangements 26, 28 to carry out a compaction mode can be done for example by an operator and in coordination with the movement of the soil compactor 12 either in the movement direction B₁ or the second movement direction B₂. Alternatively, the activation or deactivation of the vibration excitation arrangements 26, 28 can take place automatically and coordinated with the movement of the soil compactor 12 in the first movement direction B₁ or the second movement direction B₂, for example according to a predetermined compaction plan. For this purpose, the soil compactor 12 can include an activation unit, generally designated by 40, which is designed to activate the vibration excitation arrangements 26, 28 for a compaction mode to be carried out in each case for compacting an underlying surface. Since the operating mode of the vibration excitation arrangements 26, 28 assigned to the two compactor rollers 16, 22 depends on the movement direction of the soil compactor 12, a movement direction detection unit, generally designated by 42, can be provided on the soil compactor 12, for example assigned to the compactor roller 22. This can be designed, for example, to detect the direction of rotation of the compactor roller 22 and to feed movement direction information indicating this direction of rotation into the activation unit 40. Based on the information indicating the direction of rotation, the activation unit 40 then activates the two vibration excitation arrangements 26, 28 in such a way that they are operated in a suitable operating mode in the manner described hereinafter. It is to be noted that the movement direction detection unit can be designed to provide the movement direction information indicating the direction of rotation in a different manner. For example, the movement direction information can also be derived from the activation of a drive system of the soil compactor, since this activation or the mode of the drive system is clearly linked to the movement caused by the operation of the drive system and thus also to the movement direction of the soil compactor 12.

The operation of the compactor rollers 16, 22 in different operating modes with respectively activated and deactivated vibration excitation arrangements 26 and 28 is explained hereinafter with reference to FIG. 3.

In FIG. 3, the soil compactor 12 illustrated as an example in FIG. 1 is shown viewed from above on the soil 10 to be compacted. The soil compactor 12 can be used, for example, in order to be moved over the soil 10 in a plurality of successive passages according to a compaction plan and to compact its building material in the process. Each such pass is defined by a track 38 shown in FIG. 3, in which, when moving in the first movement direction B₁ or the second movement direction B₂, respectively, the soil compactor 12 compacts the building material of the soil 10 using its compactor rollers 16, 22. In general, in order to achieve the desired degree of compaction, it is necessary to carry out multiple such passes in succession in order to repeatedly load the building material of the soil 10 present in the respective track 38. This means that during multiple such passes, the soil compactor 10 is moved alternately in the first movement direction B₁ and the second movement direction B₂ essentially on the same track 38. An offset of the soil compactor 12 transverse to the movement direction can be provided between immediately successive passes guided in different movement directions, so that the tracks 38 passed over in immediately consecutive passes do not necessarily have to be completely congruent with one another.

When compacting the soil 10, the soil compactor 12 is operated in such a way that, independently of whether it is being moved in the first movement direction B₁ or the second movement direction B₂, the respective trailing compactor roller of the two compactor rollers 16, 22 is not operated in a vibratory compaction mode, in which the respective vibration excitation arrangement 26 or 28 operates in the vibratory vibration excitation mode, thus, for example, the vibration arrangement 30 is activated, while the oscillation arrangement 32 is deactivated. Advantageously, in each of the successive passes guided in different movement directions, the respective trailing compactor roller 16 or 22 is not operated in the vibratory compaction mode, but at least in the last pass, which travels over an area of the soil 10 to be compacted, represented for example by the track 38.

In order to nevertheless be able to use the particularly advantageous effect on the compaction due to the vibratory vibration excitation mode, it can be provided, for example, that at least in some of the successive passes guided in different movement directions, preferably in all such passes, the respective leading compactor roller of the two compactor rollers 16, 18 is operated in the vibratory compaction mode.

In order to ensure that trough-like depressions on the upper side of the soil 10 generated in the vibratory compaction mode of the respective leading compactor roller are smoothed out or eliminated, the respective trailing compactor roller of the two compactor rollers 16, 22 can be operated in an oscillatory compaction mode or in a static compaction mode, in which the vibration excitation arrangement 26 or 28 of the respective trailing compactor roller of the two compactor rollers 16, 22 is deactivated. Due to the exclusively static load or the flexing effect generated in the oscillatory compaction mode, irregularities on the surface of the soil to be compacted that were generated in the vibratory compaction mode of the respective leading compactor roller are efficiently eliminated, while at the same time further compaction of the soil 10 also takes place due to the static load or the flexing effect generated in the oscillatory compaction mode.

In a mode in which it is ensured that the trailing compactor roller is not operated in the vibratory mode, but for example the respective leading compactor roller is operated in the vibratory compaction mode, while the respective trailing compactor roller is operated in the oscillatory compaction mode or in the static compaction mode, whenever the movement direction of the soil compactor 12 is reversed, as it changes from a pass with movement in the first movement direction B₁ or the second movement direction B₂ to a pass with movement in the second movement direction B₂ or the first movement direction B₁, respectively, a change in the operating mode of the compactor rollers 16, 22 also takes place. This change can also take place either according to the specification of an operator or automatically. For this purpose, it is necessary, for example, to detect the movement direction of the soil compactor 12 on the basis of the direction of rotation of the compactor rollers 16 or 22 or GPS data or to provide information representing this movement direction, which can then be used in an activation unit of the soil compactor 12 to activate the vibration excitation arrangements 26, 28 assigned to the two compactor rollers 16, 22 in such a way that they are operated in the respective operating mode provided for a pass, thus vibratory compaction mode, oscillatory compaction mode, or static compaction mode.

In principle, it is also possible, if according to a compaction plan a plurality of passes are to be guided essentially over the same track 38, to provide passes in which, for example, both compactor rollers 16, 22 are operated in the static compaction mode or both compactor rollers 16, 22 are operated in the oscillatory compaction mode, while in a further part of the passes the respective leading compactor roller is operated in the vibratory compaction mode.

1. A method for operating a soil compactor, the soil compactor comprising two compactor rollers arranged at a distance from one another in the direction of a soil compactor longitudinal axis and rotatable around a respective roller axis of rotation, wherein the soil compactor is movable essentially in the direction of the soil compactor longitudinal axis in a first movement direction and a second movement direction essentially opposite to the first movement direction to compact soil material, wherein when the soil compactor moves in the first movement direction, one of the compactor rollers is a compactor roller leading in the first movement direction and the other of the compactor rollers is a compactor roller trailing in the first movement direction and when the soil compactor moves in the second movement direction, the one of the compactor rollers is the compactor roller trailing in the second movement direction and the other of the compactor rollers is the compactor roller leading in the second movement direction, wherein each of the compactor rollers is assigned a vibration excitation arrangement, wherein each vibration excitation arrangement is designed to exert an oscillation torque on the associated compactor roller around its roller axis of rotation in an oscillatory vibration excitation mode and to exert a vibration force on the assigned compactor roller essentially orthogonally to its roller axis of rotation in a vibratory vibration excitation mode, wherein each compactor roller is operable:
in an oscillatory compaction mode, wherein, in the oscillatory compaction mode, the vibration excitation arrangement assigned to a respective compactor roller is operated in the oscillatory compaction excitation mode,
in a vibratory compaction mode, wherein, in the vibratory compaction mode, the vibration excitation arrangement assigned to a respective compactor roller is operated in the vibratory vibration excitation mode,
in a static compaction mode, wherein, in the static compaction mode, the vibration excitation arrangement assigned to a respective compactor roller is deactivated,
wherein when the soil compactor is moved in a plurality of successive compactor passes over soil to be compacted with alternating movement of the soil compactor essentially in the first movement direction and essentially in the second movement direction, during at least one pass, the trailing compactor roller is not operated in the vibratory compaction mode.

2. The method as claimed in claim 1,
wherein at least in a last compactor pass of the plurality of compactor passes, the trailing compactor roller is not operated in the vibratory compaction mode.

3. The method as claimed in claim 1,
wherein, in each compactor pass of the plurality of compactor passes, the trailing compactor roller is not operated in the vibratory compaction mode.

4. The method as claimed in claim 1,
wherein, in at least one compactor pass of the plurality of compactor passes, the leading compactor roller is not operated in the vibratory compaction mode.

5. The method as claimed in claim 1,
wherein, in at least one compactor pass of the plurality of compactor passes, the trailing compactor roller is operated in the oscillatory compaction mode.

6. The method as claimed in claim 1,
wherein, in at least one compactor pass of the plurality of compactor passes, the trailing compactor roller is operated in the static compaction mode.

7. A soil compactor comprising:
two compactor rollers arranged at a distance from one another in the direction of a soil compactor longitudinal axis and rotatable around a respective roller axis of rotation, wherein the soil compactor is movable essentially in the direction of the soil compactor longitudinal axis in a first movement direction and a second movement direction essentially opposite to the first movement direction to compact soil material, wherein when the soil compactor moves in the first movement direction, one of the compactor rollers is a compactor roller leading in the first movement direction and the other of the compactor rollers is a compactor roller trailing in the first movement direction and when the soil compactor moves in the second movement direction, the one of the compactor rollers is the compactor roller trailing in the second movement direction and the other of the compactor rollers is the compactor roller leading in the second movement direction,
each of the compactor rollers is assigned a vibration excitation arrangement, wherein each vibration excitation arrangement is designed to exert an oscillation torque on the assigned compactor roller around its roller axis of rotation in an oscillatory vibration excitation mode and to exert a vibration force on the assigned compactor roller essentially orthogonally to its roller axis of rotation in a vibratory vibration excitation mode,
an activation unit for activating each vibration excitation arrangement, wherein each vibration excitation arrangement is operable by activation by the activation unit:
in an oscillatory compaction mode, wherein, in the oscillatory compaction mode, the vibration excitation arrangement assigned to a respective compactor roller is operated in the oscillatory compaction excitation mode,
in a vibratory compaction mode, wherein, in the vibratory compaction mode, the vibration excitation arrangement assigned to a respective compactor roller is operated in the vibratory vibration excitation mode,
in a static compaction mode, wherein, in the static compaction mode, the vibration excitation arrangement assigned to a respective compactor roller is deactivated,
a movement direction detection unit for providing movement direction information representing the movement direction of the soil compactor,
wherein the activation unit is designed to activate the vibration excitation arrangements based on the movement direction information in such a way that when the soil compactor is moved in a plurality of successive compactor passes over soil to be compacted with alternating movement of the soil compactor essentially in the first movement direction and essentially in the second movement direction, during at least one pass, the trailing compactor roller is not operated in the vibratory compaction mode.

8. (canceled)

9. The method as claimed in claim 2,
wherein, in each compactor pass of the plurality of compactor passes, the trailing compactor roller is not operated in the vibratory compaction mode.

10. The method as claimed in claim 1,
wherein, in each compactor pass of the plurality of compactor passes, the leading compactor roller is not operated in the vibratory compaction mode.

11. The method as claimed in claim 1,
wherein, in each compactor pass of the plurality of compactor passes, the trailing compactor roller is operated in the oscillatory compaction mode.

12. The method as claimed in claim 1,
wherein, in each compactor pass of the plurality of compactor passes, the trailing compactor roller is operated in the static compaction mode.
